(19) United States
(12) Patent Application Publication
(10) Pub. No.: US 2016/0046477 A1
(43) Pub. Date: Feb. 18, 2016

(54) INSTALLATION FOR FEEDING, FILLING AND CAPPING CONTAINERS

(71) Applicant: AZIONARIA COSTRUZIONI MACCHINE AUTOMATICHE A.C.M.A. S.P.A., Bologna (IT)

(72) Inventors: Marco CARRARA, Stiore di Monteveglio (IT); Gianpietro ZANINI, Montanara di Curtatone (IT)

(21) Appl. No.: 14/783,322

(22) PCT Filed: Apr. 18, 2014
(86) PCT No.: PCT/IB2014/060831

§ 371 Date: Oct. 8, 2015

(30) Foreign Application Priority Data
Apr. 22, 2013 (IT) B02013A000179

(51) Int. Cl. B67C 7/00; B67C 3/20; B67C 3/02

(52) U.S. Cl. CPC B67C 7/0033; B67C 3/023; B67C 3/202

(57) ABSTRACT

An installation for packaging a measured quantity of a liquid product in a corresponding container advancing along a feed path that includes a filling station equipped with a plurality of product dispensers and a capping station located downstream of the filling station for applying a cap to each previously filled container; the dispensers are movable along an axis between a rest position at a rest zone away from the feed path and a working position at a working zone aligned with the feed path; the installation includes a second group of dispensers movable along the axis between a respective rest position at a respective rest zone away from the feed path and a respective working position at a respective working zone aligned with the feed path.

### TECHNICAL FIELD

This invention relates to a product packaging installation and, more specifically, to an installation for filling containers with liquid products, loose materials or powders and for applying a cap to each container.

For convenience, express reference is hereinafter made to liquid products but without thereby limiting the scope of the invention.

### BACKGROUND ART

Prior art installations for packaging liquid products in containers, for example, bottles, basically comprise a filling station into which the containers are fed, normally by a conveyor belt, for example. The filling station comprises a plurality of filling nozzles which are mounted above the conveyor belt and each of which is lowered over a corresponding container in order to dispense a measured quantity of a predetermined liquid product, such as, for example, a liquid detergent or the like, to which express reference is made in this description without limiting the scope of the invention.

The nozzles are fed from a product reservoir which also comprises buffer tanks located, for example, above the nozzles themselves.

Downstream of the filling station, in a bottle feed direction, the reference packaging installations comprise a capper or capping machine which applies a cap to each container previously filled with the product dispensed.

The capping machine comprises a plurality of applicator heads, each of which applies a corresponding cap.

According to the type of cap to be applied, which depends, for example, on the container, product or size of the container, the capping machine may be equipped with suitable applicator heads.

After the capping machine, the detergent packaged in the respective containers is sent on to labelling, packing and storage stations.

One problem with prior art installations arises in connection with changeover to a different product to be dispensed.

In effect, in the case of a changeover, the entire installation must be shut down in order to clean the buffer tanks and all the nozzles in order to totally remove the old product before adding the new product.

The cleaning operations, which must be particularly thorough, require considerable time and effort and lead to lengthy down times involving the filling station and, consequently, the entire installation.

A further problem arises when changing over to different container size or type and thus, different cap type.

Following a container changeover, as mentioned, it is often necessary to change the cap type and, as a result, to replace the cap applicator heads.

The capping machine must therefore be stopped in order to replace the applicator heads, which means shutting down the entire installation.

These problems usually lead to an overall loss of installation efficiency on account of the shutdowns necessary for product changeovers and/or more generally speaking, for changeovers to different sizes of containers to be filled.

### DISCLOSURE OF THE INVENTION

In this context, the main technical purpose of this invention is to propose a product packaging installation which is free of the above mentioned problems.

More specifically, the invention has for an aim to provide a packaging installation where down times due to changeovers to different types of product packaged are shorter than in the prior art.

Another aim of the invention is to provide a packaging installation where down times due to changeovers to different sizes of containers to be filled are shorter than in the prior art.

### BRIEF DESCRIPTION OF THE DRAWINGS

Further features of the invention and its advantages are more apparent in the non-limiting description below, with reference to a preferred but non-exclusive embodiment of an installation for packaging liquid products, as illustrated in the accompanying drawings, in which:

FIG. 1 illustrates an installation according to this invention in a schematic perspective view with some parts cut away for greater clarity;

FIG. 2 illustrates the installation of FIG. 1 in a top plan view suitably interrupted and partly in blocks;

FIG. 3 illustrates the installation of FIG. 1 in a front view from A suitably interrupted and with some parts cut away;

FIGS. 4 and 5 illustrate a first and a second scaled-up detail of the installation of the preceding figures in the view of FIG. 3;

FIG. 6 illustrates the installation of FIG. 1 in a side view from B suitably interrupted;

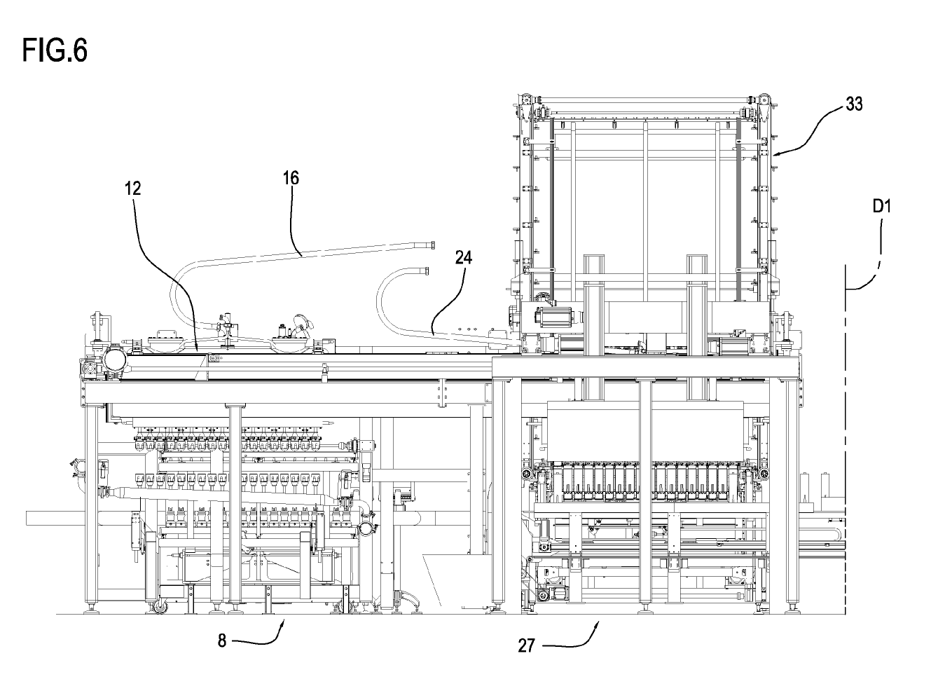

FIG. 7 illustrates a detail of the installation according to this invention in a schematic perspective view.

### DETAILED DESCRIPTION OF PREFERRED EMBODIMENTS OF THE INVENTION

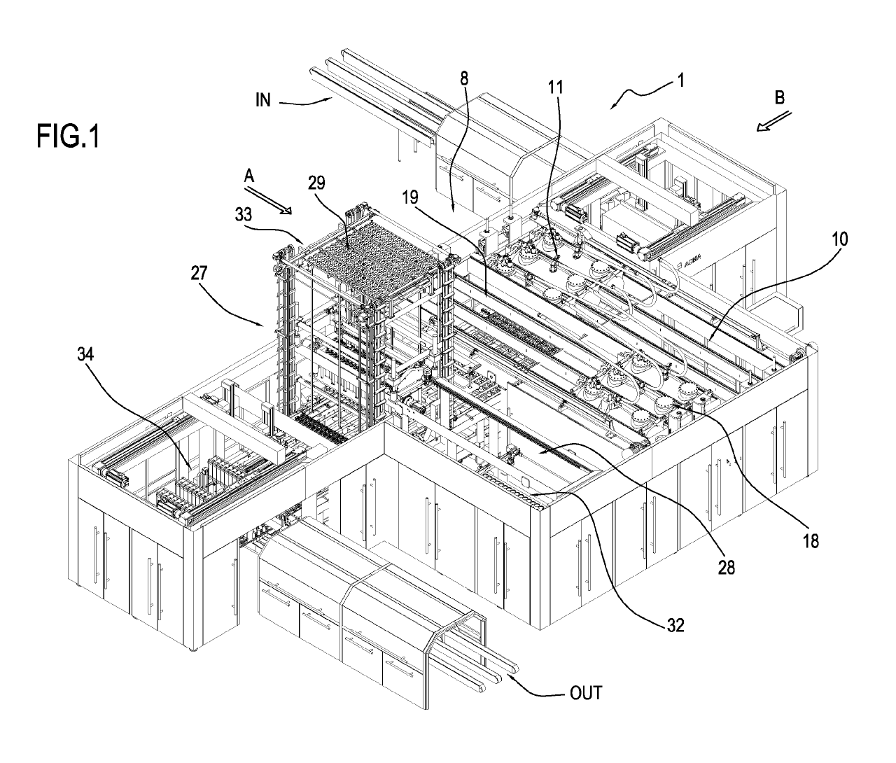

With reference to FIG. 1, the numeral 1 denotes an installation for packaging liquid products according to this invention.

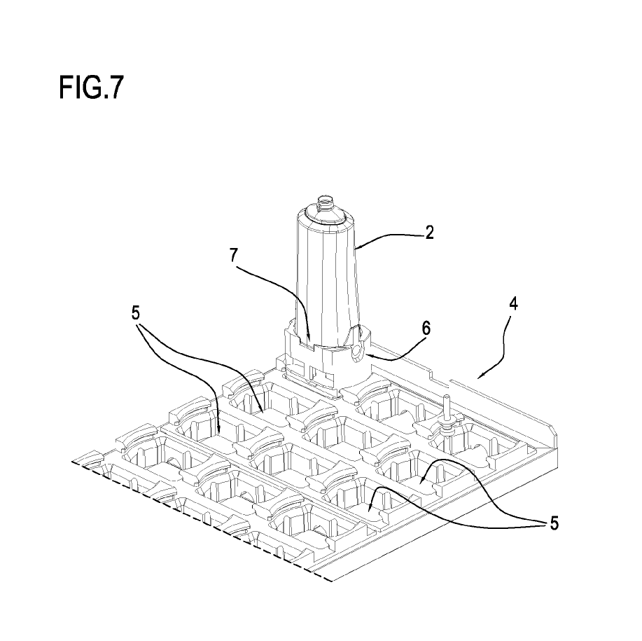

The installation 1 is designed to package a measured quantity of a liquid product, for example a detergent, in a corresponding container 2 illustrated, for example, in FIG. 7.

Advantageously, the installation simultaneously fills a plurality of containers 2 with the respective measured quantity of product and applies to each container a corresponding cap, not illustrated.

The installation 1 has an infeed end IN for the empty containers 2 and an outfeed end OUT for the full, capped containers 2.

The installation 1 comprises feeding means by the containers 2 are directed in an advancing direction V along a feed path P.

The feeding means comprise a conveyor 3, for example a conveyor belt, movable along the feed path P and a plurality of trays 4, partly illustrated for example in FIG. 7, advanced by the conveyor 3.

With reference in particular to FIG. 7, it may be observed that the tray 4 has a plurality of recesses 5, each designed to house a respective container 2.

As illustrated, the feeding means for the containers 2 comprise a plurality of supporting elements 6, of which only one is illustrated, for convenience, and each of which is designed to receive a corresponding container 2.

The supporting element 6 for receiving the container 2 is shaped to fit into the recess 5 of the tray 4 and in turn has an inner recess 7 for receiving the container 2.

The containers 2 are transported by means of the trays 4 which in turn mount the supporting elements 6 in which the containers 2 are inserted.

The supporting elements 6 have an outside surface shaped to fit into the corresponding recess 5 on the tray 4 and an inside surface delimiting the recess 7, shaped to engage/receive the container 2.

Advantageously, therefore, the trays 4 are standard, irrespective of the type of container 2, whilst only the supporting elements 6 vary for each type of container 2.

When changing over to a different size of containers 2, it is sufficient to place the new containers 2 with the respective supporting elements 6 on the trays 4.

The installation 1 comprises a filling station 8 for the containers 2, where a measured quantity of the product is filled into a corresponding container 2.

The filling station 8 is hereinafter described only insofar as necessary for understanding this invention.

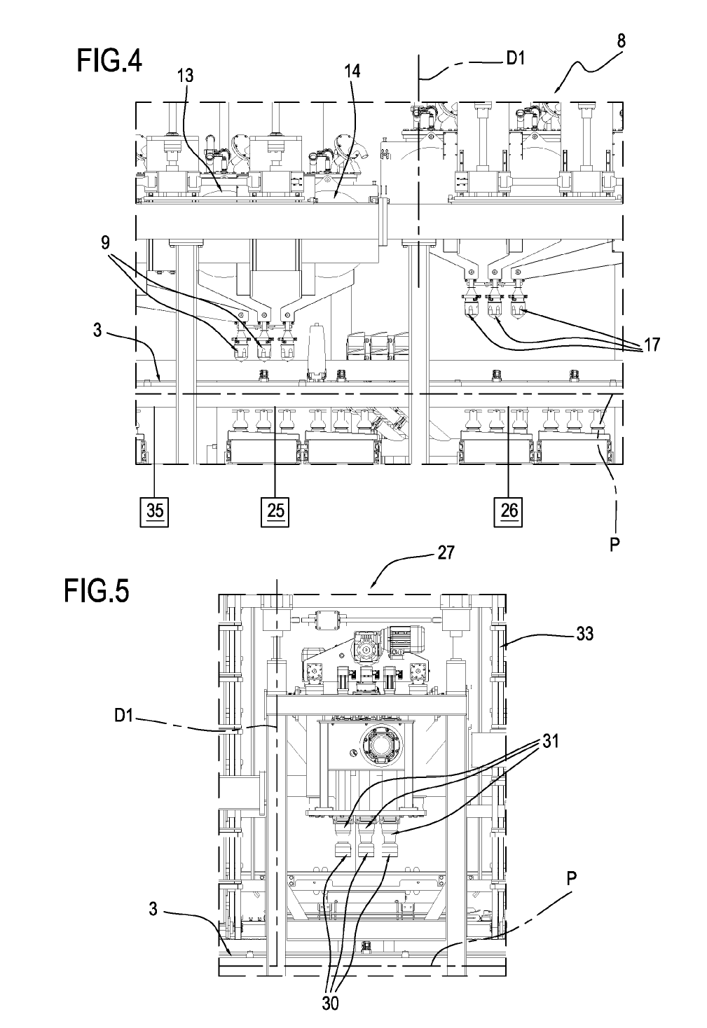

With reference in particular to FIG. 4, it may be observed that the filling station 8 comprises a plurality of dispensers 9 for delivering the measured quantities of product, and each designed to fill a corresponding container 2 being advanced along the path P.

The dispensers 9 are movable relative to the feeding means for the containers 2 along an axis D1 transversal to the path P, in particular perpendicular thereto.

In practice, the axis D1 extends vertically relative to the plane in which the trays 4 lie.

More specifically, the dispensers 9 are movable relative to the trays 4, and thus relative to the containers 2 housed in the trays 4 present on the path P and waiting in the filling station 8, between a position away therefrom and a position close thereto, as shown in FIG. 4, as a function of the height, or in general terms, the size of the containers 2 measured along the axis D1.

The filling station 8 comprises means for feeding the liquid product to the dispensers 9 and in fluid communication therewith in order to supply the dispensers with the product to be dispensed.

The dispensers 9 are movable along a second axis D2 transversal to the first axis D1 path P and, preferably, to the path P along which the containers 2 are advanced.

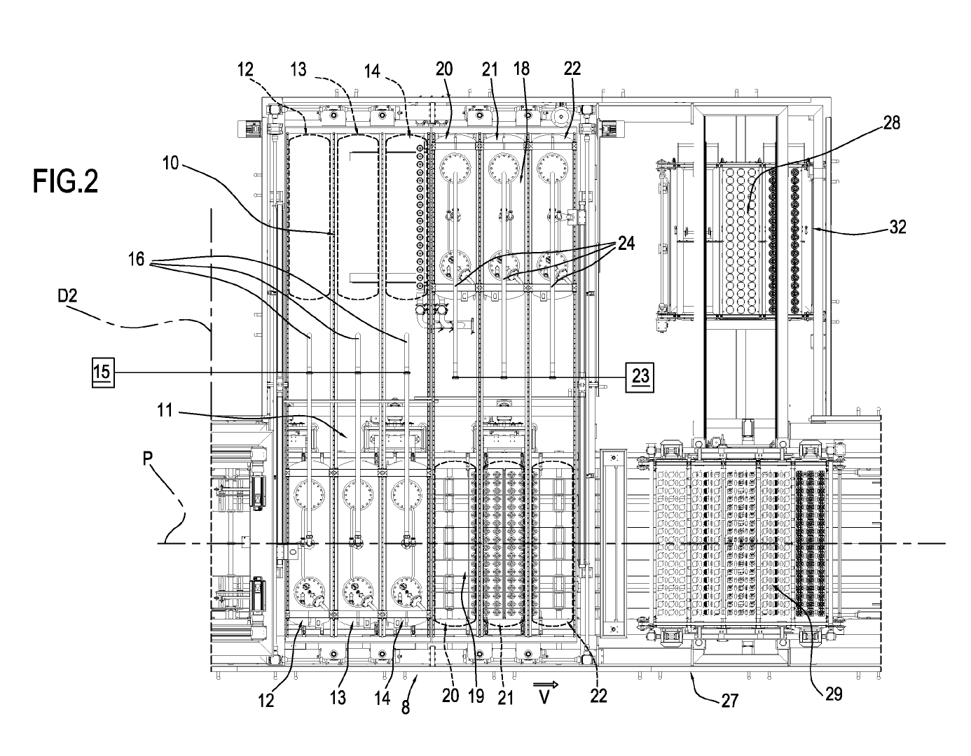

With reference in particular to FIG. 2, the dispensers 9 are movable between a rest position at a rest zone 10 away from the feed path P and an operating position at a working zone 11 aligned with the feed path along the axis D1.

In practice, when the dispensers 9 are at the rest position, they do not interfere with the path P along which the containers 2 are advanced.

As illustrated, the feeding means by which the dispensers 9 are fed are also at least partly movable between the rest zone 10 and the working zone 11 along the direction D2.

Advantageously, the movable parts of the feeding means connected to the dispensers 9 are movable between the rest zone 10 and the working zone 11 as one with the dispensers 9.

More precisely, the feeding means by which the dispensers 9 are fed comprise at least one buffer tank 12, 13, 14 in communication with the dispensers 9 and movable between the rest zone 10 and the working zone 11.

In FIG. 2 the buffer tanks 12, 13, 14 are schematically drawn with dashed lines at the rest zone 10.

In the preferred embodiment illustrated by way of example, the feeding means comprise three distinct buffer tanks 12, 13, 14, each in communication with a respective product reservoir and with the respective dispensers 9.

For convenience, the distinct reservoirs are schematically represented as a single block 15.

The buffer tanks 12, 13, 14 are connected to the reservoirs 15 by way of ducts 16, which are at least partly flexible and which allow the buffer tanks 12, 13, 14 to move, as mentioned above, between the rest zone 10 and the working zone 11.

In practice, the buffer tanks 12, 13, 14 are movable between a maintenance position in the rest zone 10 and a working position in the working zone 11 as one with the corresponding dispensers 9.

In practice, when the buffer tanks 12, 13, 14 are at the maintenance position, they do not interfere with the path P along which the containers 2 are advanced.

Advantageously, the tanks 12, 13, 14, like the dispensers 9, are mounted above the path P.

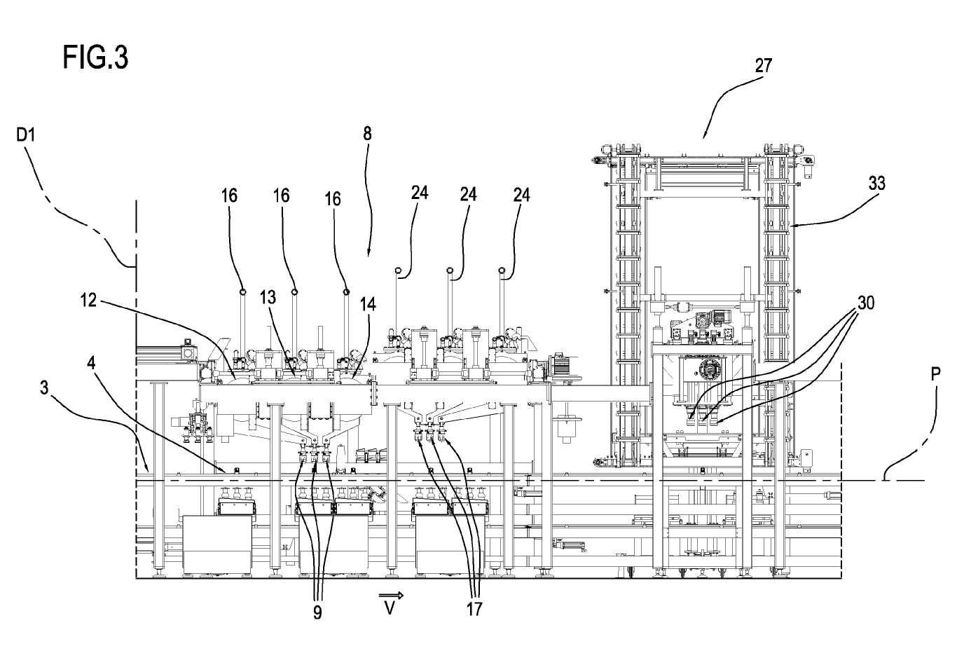

As illustrated in particular in FIGS. 3 and 4, the filling station 8 comprises a second set of dispensers 17.

The filling station 8 comprises a plurality of dispensers 17 for delivering the measured quantities of product, and each designed to fill a corresponding container 2 being advanced along the path P.

The dispensers 17 are movable along the axis D1 relative to the trays 4, and thus relative to the containers 2 housed in the trays 4, present on the path P and waiting in the filling station 8, as a function of the height, or in general terms, the size of the containers 2 measured along the axis Dl.

The filling station 8 comprises means for feeding the liquid product to the dispensers 17 and in fluid communication therewith in order to supply the dispensers with the product to be dispensed.

The dispensers 17 are movable along the second axis D2 between a rest position at a rest zone 18 away from the feed path P and a working position at a working zone 19 aligned with the feed path along the axis Dl.

In practice, when the dispensers 17 are at the rest position, they do not interfere with the path P along which the containers 2 are advanced.

As illustrated, the feeding means by which the dispensers 17 are fed are also at least partly movable between the rest zone 18 and the working zone 19 along the direction D2.

Advantageously, the movable parts of the feeding means connected to the dispensers 17 are movable between the rest zone 18 and the working zone 19 as one with the dispensers 17.

More precisely, the feeding means by which the dispensers 17 are fed comprise at least one buffer tank 20, 21, 22 in communication with the dispensers 17 and movable between the rest zone 18 and the working zone 11.

In FIG. 1 the buffer tanks 20, 21, 22 are schematically drawn with dashed lines at the working zone 19.

Advantageously, the tanks 20, 21, 22, like the dispensers 17, are mounted above the path P.

In the preferred embodiment illustrated by way of example, the feeding means comprise three distinct buffer tanks 20, 21, 22, each in communication with a respective product reservoir and with the respective dispensers 17. For convenience, the distinct reservoirs are schematically represented as a single block 23.

The buffer tanks 20, 21, 22 are connected to the reservoirs 23 by way of ducts 24, which are at least partly flexible and which allow the buffer tanks 20, 21, 22 to move, as mentioned above, between the rest zone 18 and the working zone 19.

In practice, the buffer tanks 20, 21, 22 are movable between a maintenance position in the rest zone 18 and a working position in the working zone 19 as one with the corresponding dispensers 17.

In practice, when the buffer tanks 20, 21, 22 are at the maintenance position, they do not interfere with the path P along which the containers 2 are advanced.

The working zone 19 of the dispensers 17 is located downstream of the working zone 10 of the dispensers 9 along the advancing direction V of the containers 2.

That way, in use, it is possible to use one group of dispensers and the related buffer tanks to fill the containers 2, keeping it at the working position, while maintenance—for example, cleaning or changeover—is carried out on the other dispensers and related buffer tanks at the rest zone, outside the feed path P of the containers and thus without shutting down the entire installation.

Advantageously, the installation 1 comprises a weighing system by which the containers 2 are weighed.

In a preferred embodiment, the weighing system comprises a weighing station located upstream of the container filling station 8 along the advancing direction V in order to measure the weight of the containers 2 themselves, that is to say, to calculate their tare weight.

The weighing station for calculating the tare weight comprises a weighing apparatus, represented schematically, for convenience, as a block 35 in FIG. 4.

The weighing apparatus 350 for the containers 2, is located under the conveyor 3 along the axis D1 and comprises a plurality of weighing units, not illustrated, movable between a lowered position and a raised weighing position where each measures the weight of one container 2.

More precisely, the weighing units, corresponding in number to the number of containers to be weighed, weigh the respective container 2 together with the corresponding supporting element 6.

The outside surface of the supporting element 6 and the inside surface of the recess 5 in the tray 4 are shaped to allow weighing to be carried out, that is to say, in such a way as to allow the supporting element 6 to be released from the tray 4 under the action of the weighing unit.

As mentioned, the weighing apparatus 35 performs a first weighing operation on the empty containers 2 upstream of the filling station in order to quantify the tare weight given by the container 2 together with the supporting element 6.

The aforementioned weighing system comprises a second weighing apparatus, schematically represented as a block 25 in FIG. 4, for the containers 2 in the working zone 11.

The weighing apparatus 25 for the containers 2 is positioned under the conveyor 3 along the axis D1 and is substantially the same as the weighing apparatus

The weighing apparatus 24 comprises a plurality of weighing units, not illustrated, movable between a lowered position and a raised weighing position where each measures the weight of one container 2.

More precisely, the weighing units weigh the container 2 together with the corresponding supporting element 6.

In a preferred embodiment, each weighing unit of the weighing apparatus 25 measures the weight of the respective container 2 instant by instant while it is being filled and on reaching the specified weight, stops the filling dispensers 9.

A weighing apparatus identical to those described above and schematically represented as a block 26, for weighing the containers 2, is provided in the working zone 19.

Downstream of the filling station 8 along the advancing direction V of the containers 2, the installation 1 comprises a capping station 27 where caps are applied to the previously filled containers 2.

The capping station 27 comprises means for applying a cap, not illustrated, to each corresponding container 2 filled in the filling station 8.

The cap applicator means, being of substantially known type, are described only insofar as necessary for understanding this invention.

The cap applicator means and the aforementioned feeding means by which the containers 2 are advanced are movable relatively along the axis D1 between a spaced-apart position and a close-together position for applying the cap.

In substantially known manner, the cap applicator means in the capping station 27 are lowered towards the full containers 2 waiting in the selfsame station 27 in order to apply the caps to the containers.

The applicator means are movable along the axis D2 between a first non-operating position at a rest zone 28 away from the feed path P and a second operating position in a working zone 29 aligned with the feed path P along the axis D1.

With reference in particular to FIG. 5, the applicator means comprise a plurality of capping heads 30, each shaped, in known manner not described to move and apply the cap to the container 2.

The applicator means also comprise a plurality of mounting members 31, one for each capping head 30 and which the heads 30 are mounted to.

The applicator means further comprise releasable engagement means operating between the capping head 30 and the respective mounting member 31.

The releasable engagement means are structured to engage and disengage the capping head 30 to and from the corresponding mounting member 31.

Advantageously, the releasable engagement means are of the type commonly known as “quick disconnect couplings”, for example of the type used in machine tools to fit and remove the tools.

The installation 1 comprises a reservoir 32 for storing the heads 30 and located in the rest zone 28.

The mounting members 31 are movable between the reservoir 32 and the operating zone 29 to engage and/or release the heads 30 in the reservoir 32 and to apply the caps in the zone 29.

In practice, the heads 30 are engaged by means of a quick disconnect system to the respective coupling means and different types of heads 30, for example used for caps for different containers 2, are stored in the reservoir 32.

When changing over to a different size of container 2 and hence size of cap, the applicator means, in particular the mounting members 31 for the heads 30 are moved to the reservoir 32.

When they reach the reservoir 32, the mounting members 31 release the previously used heads 30 and engage the heads 30 for the new size.

Thus, even when changing over to a different size of containers 2 and respective caps, the quick disconnect system provided, like the ones used to change tools in machine tools, allows the heads 30 to be changed quickly and without shutting down the installation for prolonged lengths of time.

In the embodiment described by way of example, the capping station 27 comprises a system 33 for feeding the caps to the heads 30.

In the preferred embodiment described, the feeding system 33 extends vertically along the axis D1 above the operating zone 29.

With reference in particular to FIG. 1, it may be observed that downstream of the capping station 27 along the direction V, the installation 1 comprises a station 34, of substantially known type and not further described, for arranging the full containers.

The installation as described brings important advantages.

Moving the capping heads and the dispensers together with the buffer tanks makes it possible to speed up changeover operations, both when changing product and size of containers and/or caps.

The tanks and dispensers positioned outside the container feed path can be cleaned or, more generally, subjected to other maintenance without shutting down the installation. Similarly, the down time of the installation for changing capping heads is considerably reduced thanks to the adoption of a quick disconnect system for engaging and disengaging the heads to and from the corresponding mounting members.

The adoption of standard trays capable of advancing containers of any size also contributes to an overall reduction of down time for product or size changeovers.

Advantageously, also, in alternative embodiments not illustrated, the installation comprises more groups of dispensers provided with respective feeding means as a function of the products required to be available quickly in the installation itself.

It should also be noted that in the embodiment described by way of example, it is possible to package from one to three different products simultaneously in the same installation since there are three buffer tanks connected to respective reservoirs and to respective groups of dispensers.

1. An installation for packaging at least one measured quantity of a liquid product in a corresponding container, the installation comprising
feeding means by which a plurality of containers are directed in an advancing direction along a feed path
a filling station where a measured quantity of the product is filled into a corresponding container, the filling station comprising a plurality of dispensers for delivering the measured quantity and liquid product supply means which are in communication with the dispensers;
a capping station located downstream of the filling station, in the advancing direction, the capping station comprising applicator means by which a cap is placed on each container filled at the filling station, the applicator means and the feeding means being movable relative to each other along a first axis between a spaced apart position and a close together position for applying the cap,
the installation wherein the dispensers are movable along a second axis transversal to the first axis and to the feed path between a first rest position at a first rest zone away from the feed path and a first working position at a first working zone aligned with the feed path along the first axis and in that it comprises second dispensers for delivering the measured quantity and second liquid product supply means which are in communication with the second dispensers; the second dispensers being movable along the second axis transversal to the first axis between a second rest position at a second rest zone away from the feed path and a second working position at a second working zone aligned with the feed path along the first axis.

2. The packaging installation according to claim 1, wherein the first supply means are at least partly movable between the first rest zone and the first working zone along the second axis.

3. The packaging installation according to claim 2, wherein the first supply means are at least partly movable between the first rest zone and the first working zone along the second axis together with the first dispensers.

4. The packaging installation according to claim 1, wherein the first supply means comprise at least one buffer tank in communication with the first dispensers and movable between the first rest zone and the first working zone.

5. The packaging installation according to claim 1, wherein the second supply means are at least partly movable between the second rest zone and the second working zone along the second axis.

6. The packaging installation according to claim 5, wherein the second supply means are at least partly movable between the second rest zone and the second working zone along the second axis together with the second dispensers.

7. The packaging installation according to claim 1, wherein the second supply means comprise at least one second buffer tank in communication with the second dispensers and movable between the second rest zone and the second working zone.

8. The installation according to claim 1, wherein the filling station comprises a first weighing apparatus for the containers in the first working zone and a second weighing apparatus for the containers in the second working zone.

9. The packaging installation according to claim 1, wherein the applicator means are movable along the second axis between a first non-operating position in a dwell zone away from the feed path and a second operating position at a working zone aligned with the feed path along the second axis.

10. The packaging installation according to claim 9, wherein the applicator means comprise at least one capping head, at least one mounting member for the capping head and releasable engagement means operating between the capping head and the mounting member to engage and disengage the capping head from the corresponding mounting member.

11. The packaging installation according to claim 10, wherein it comprises a reservoir for the capping head in the dwell zone, the mounting member being movable between the reservoir and the working zone, the mounting member engaging and disengaging the capping head in the reservoir.

12. The packaging installation according to claim 1, wherein the feeding means comprise a conveyor movable along the feed path, at least one tray advanced by the conveyor, at least one supporting element which holds the container and which is coupled to the tray, the tray having a recess for receiving the supporting element and the supporting element having a second recess for receiving the container.
